(19) United States
(12) Patent Application Publication
(10) Pub. No.: US 2017/0228674 A1
(43) Pub. Date: Aug. 10, 2017

(54) System and Method for Enhancements of Financial Services Device Features

(71) Applicants: William BUDDE, Dublin, OH (US); Giancarlo Miranda, Columbus, OH (US); Joseph Bradley Nolan, New Albany, OH (US); Katherine Dill, San Francisco, CA (US); Alison Maiorano, San Francisco, CA (US); David Scott, Belmont, CA (US); Hanna Wickholm, San Francisco, CA (US); Steven Siamac Selzer, San Francisco, CA (US); Patrick Weiss, San Francisco, CA (US)

(72) Inventors: William BUDDE, Dublin, OH (US); Giancarlo Miranda, Columbus, OH (US); Joseph Bradley Nolan, New Albany, OH (US); Katherine Dill, San Francisco, CA (US); Alison Maiorano, San Francisco, CA (US); David Scott, Belmont, CA (US); Hanna Wickholm, San Francisco, CA (US); Steven Siamac Selzer, San Francisco, CA (US); Patrick Weiss, San Francisco, CA (US)

(73) Assignee: JPMorgan Chase Bank, N.A., New York, NY (US)

(21) Appl. No.: 13/456,818

(22) Filed: Apr. 26, 2012

(51) Int. Cl. G06Q 20/20; G06F 3/041

(52) U.S. Cl. CPC G06Q 10/0635

(57) ABSTRACT

A number of enhancements for financial services devices are provided. These enhancements may be in the form of user interface improvements as well as increasing functionality of the financial services device. The enhancements include: a height adjustment feature for the user interface, a hover/touch and hold enhancement for the user interface, and a service capability enhancement to allow the financial services device to support transactions with pre-paid/stored value cards.

### FIELD OF THE INVENTION

The invention relates generally to providing financial services, such as at financial institution branch offices and through devices such as financial services kiosks.

### BACKGROUND OF THE INVENTION

Financial institution customers use Automated Teller Machines (“ATMs”) to perform certain financial institution transactions. At traditional ATMs, the customers have a limited selection of options for tasks and transactions to perform, as well as limited options for customization of their experience at the ATM. A level of personalization or modification of the options presented to the customer upon log-in is possible with some ATMs. U.S. Pat. No. 7,822,684, entitled “Personalized Bank Teller Machine,” describes one such system for modifying or personalizing the options presented to a user of an ATM. U.S. Pat. No. 7,814,016, entitled “Personal Teller System and Method of Remote Interactive and Personalized Banking,” also describes providing personalized services through a teller machine, including using audio and/or video communications between a customer and a teller at the teller machine.

These and other deficiencies exist.

### SUMMARY OF THE INVENTION

Exemplary embodiments include a computer implemented method. The method includes detecting, by a computer processor, a presence of a customer at a financial transaction device; adjusting, electronically, a display screen to a first position on the financial transaction device in response to the detected presence; receiving a log-on request at the financial transaction device; and providing an option for the customer to adjust the display screen to a second position.

Another exemplary embodiment includes a computer implemented method. The method includes: detecting, by a computer processor, a presence of a customer at a financial transaction device; adjusting, electronically, a display screen to a first position on the financial transaction device in response to the detected presence; receiving a log-on request at the financial transaction device; and positioning, by the computer processor, the display to a second position based on a saved setting associated with the customer.

Another exemplary embodiment includes a financial transaction device. The financial transaction device includes an interface for customer interaction; at least one optical device capable of detecting a presence of a customer; and a first display surface capable of electronically displaying at least one display screen, the at least one display screen being electronically movable on the first display surface in response to the detected presence of the customer such that upon detecting the presence of the customer the financial transaction device automatically adjusts the positioning of the at least one display screen upon the first display surface.

Another exemplary embodiment includes a computer implemented method. The method includes receiving, by a computer processor, a menu selection on a touch display screen associated with a financial transaction device; and causing, by the computer processor, a pop-up display to appear on the touch display screen containing information related to the menu selection wherein the pop-up display appears in response to contact with the touch display screen for a predetermined amount of time.

Another exemplary embodiment includes a computer implemented method. The method includes receiving, by a computer processor, a log in request, from a customer, at a financial transaction device wherein the customer has at least one financial account with a financial institution associated with the financial transaction device and has at least one pre-paid card account with the financial institution associated with the financial transaction device; presenting a menu selection screen, comprising menu selections pertaining to transactions related to the at least one pre-paid card account, to the customer, on a display; receiving, by the computer processor, a selection of an item from the menu selection screen; and performing an action corresponding to the selected item on the at least one pre-paid card account.

These and other embodiments and advantages of the invention will become apparent from the following detailed description, taken in conjunction with the accompanying drawings, illustrating by way of example the principles of the various exemplary embodiments.

### BRIEF DESCRIPTION OF THE DRAWINGS

FIG. 1 is a diagram of a system in accordance with an exemplary embodiment.

FIGS. 2A and 2B are flow charts of methods of interfacing with a financial services kiosk having a height adjustable display in accordance with an exemplary embodiment.

FIG. 3 depicts a device for financial transactions in accordance with an exemplary embodiment.

FIG. 4 depicts a flow chart of a method of interfacing with a financial services kiosk having a hover feature in accordance with an exemplary embodiment.

FIGS. 5A and 5B depict a menu selection screen of a financial services kiosk in accordance with an exemplary embodiment.

FIG. 6 depicts a method of conducting a transaction for a pre-paid card at a financial services kiosk according to an exemplary embodiment.

### DETAILED DESCRIPTION OF THE PREFERRED EMBODIMENTS

It will be readily understood by those persons skilled in the art that the embodiments of the inventions described herein are capable of broad utility and application.

Accordingly, while the invention is described herein in detail in relation to the exemplary embodiments, it is to be understood that this disclosure is illustrative and exemplary of embodiments of the invention and is made to provide an enabling disclosure of the invention. Accordingly, the disclosure is not intended to be construed to limit the embodiments of the invention or otherwise to exclude any other such embodiments, adaptations, variations, modifications and equivalent arrangements. While the various embodiments of the present invention are described in the context of financial transaction/services devices and providing of financial service through such devices, the methods and systems described herein may be applied to other related services involving interaction with similar devices.

The following descriptions are provided of different configurations and features according to exemplary embodiments. These configurations and features may relate to providing financial services through financial services devices. While certain nomenclature and types of applications/hardware are described, other names and application/hardware usage is possible and the nomenclature provided is done so by way of non-limiting examples only. Further while particular embodiments are described, it should be appreciated that the features and functions of each embodiment may be combined in any combination as is within the capability of one of ordinary skill in the art. The attached Figures provide additional details regarding the present invention. It should also be appreciated that these exemplary embodiments are provided as non-limiting examples only.

Financial services devices, as used herein, may include machines, kiosks, and stations for performing financial services transactions. These devices may include, but are not limited to, automated teller machines (“ATMs”), personal teller machines (“PTMs”), financial self-service devices, financial services kiosks, financial transaction devices, portable electronic devices, money machines, cash machines, bank machines, and bancomats.

According to exemplary embodiments, a number of enhancements for financial services devices are envisioned. These enhancements may be in the form of user interface improvements as well as increasing functionality of the financial services device. The enhancements include: a height adjustment feature for the user interface, a hover/touch and hold enhancement for the user interface, and a service capability enhancement to allow the financial services device to support transactions with pre-paid/stored value cards. A brief description of each follows.

Customizable Height:

Financial services devices may be equipped with one or more cameras that are able to determine the approximate height of the customer (e.g., using facial recognition), and the system then calculates the optimal height at which to show a user interface. This feature may be used on financial services devices having a large touch screen display. The user can have the option to manually adjust the height of the user interface, such as moving it higher or lower than what the system calculated, by touching and dragging the user interface on the screen. In addition, the user may be able to set a predetermined height as a customizable option, so that upon authenticating or logging into the device, the height of the display is automatically set at the level pre-selected by the user (even if the height had been previously adjusted based on the user's height). The user may further be able to customize other screen options, such as font size and color, as well as options displayed thereon. This feature then provides functionality to enable the user to further customize their experience using the financial services device. Additionally, this feature may have Americans with Disabilities Act (“ADA”) compliance features to ensure the feature is available to all customers.

Hover/Touch-and-Hold:

A capability is provided at a touchscreen display of the financial services device such that a continuous touch on a spot on the screen provides additional information or functionality to the user. For example, the user may maintain a consistent touch on an account listing screen, and after a pre-determined amount of time (e.g., 2 seconds), additional information about the accounts is be revealed; that information is then removed from the screen when the user releases the touch from the screen. The function may allow a user to set some of his/her accounts by default to be hidden and are revealed after the touch-and-hold is executed. In this manner, the customer may hide some transactions from the main menu list, which would be revealed after the touch-and-hold is executed. This feature accordingly offers both convenience and security for the user.

Prepaid Card Servicing:

Financial services devices may have the capability to support transactions involving pre-paid or stored value cards. It should be appreciated that the terms “pre-paid card” or “stored value card” may be used interchangeably herein, and the use of one term is not meant to exclude the other. The user is able to perform a full set of automated transactions through the financial services device, such as withdraw, reload, transfer between stored value cards (including cards related to differing accounts and even cards associated with different customers), transfer to or from a stored value card and bank DDA account, balance inquiry, transaction inquiry/mini-statement. The pre-paid/stored value card may be a physical card or a virtual card.

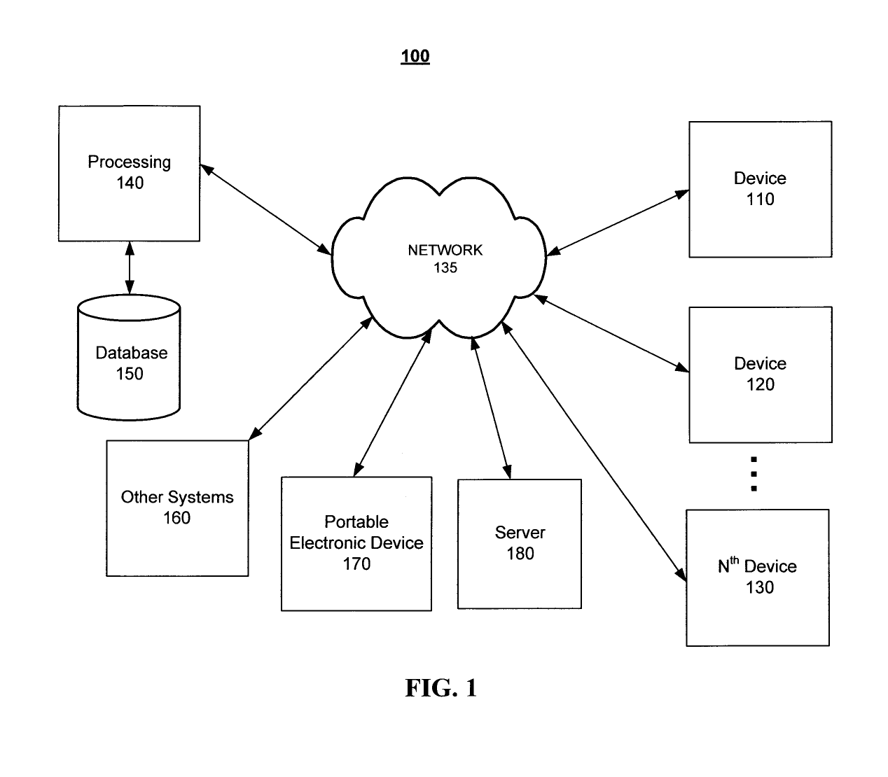

FIG. 1 is a system according to an exemplary embodiment of the invention. System 100 may provide various functionality and features associated with the program. More specifically, system 100 may include a device 110, a second device 120, and an Nth device 130, a network 135, a processing module 140, a database 150, and other systems 160. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. For example, some of the modules or functionality associated with the modules may be supported by a separate application or platform. Other implementations and architectures may be realized. It should be appreciated that system 100 may be integrated into and run on a computer, which may include a programmed processing machine which has one or more processors. Such a processing machine may execute instructions stored in a memory to process the data. System 100 may be integrated into and run on one or more computer networks which may each have one of more computers associated therewith.

As noted above, the processing machine executes the instructions that are stored in the memory or memories or persistent or non-transitory data storage devices to process data. This processing of data may be in response to commands by a user or users of the processing machine, in response to previous processing, in response to a request by another processing machine and/or any other input, for example. As described herein, a module performing functionality may have a processor.

According to exemplary embodiments, the system 100 may be configured to carry out the methods as described herein. The system 100 may have device 110 associated therewith. A second device 120 and an Nth device 130 may be further associated with the system 100. The devices 110, 120, and 130 may each be a processing machine. Each device 110, 120, and 130 may include software and/or modules to implement the methods described herein according to exemplary embodiments. Each device 110, 120, and 130 may provide processing, display, storage, communications, and execution of commands in response to inputs from a user thereof and respond to requests from the software and/or modules.

The devices 110, 120, and 130 may each serve as a client side. Each device 110, 120, and 130 may be a “fat” client, such that the majority of the processing may be performed on the client. Alternatively, the device 110, 120, and 130 may each be a “thin” client, such that the majority of the processing may be performed in the other components of the system 100 as best shown in FIG. 1. The devices 110, 120, and 130 may be configured to perform other functions and processing beyond the methods described herein. The devices 110, 120, and 130 may each be a part of a larger system associated with the financial institution. The devices 110, 120, and 130 may be multi-functional in operation.

Each device 110, 120, and 130 may have a display and an input device associated therewith. The display may be monochrome or color. For example, the display may be a plasma, liquid crystal, or cathode ray tube type display. The displays may be touch screen type displays. The devices 110, 120, and 130 may have more than one display. The multiple displays may be different types of displays. The display may have sub-displays there on. For example, the device 110, 120 and 130 may have a large display surface. The display for the user interface may occupy a portion or less than the whole of the large display surface.

The display may be adjustable in both location and in orientation/sizing on the device 110, 120, and 130. The display may be adjusted by the device automatically based on a set of inputs. For example, one or more cameras, optical sensors, or other sensing devices may be used to adjust the height of the display based upon a sensed height of the user at the device. The sensors may be computer controlled and may capture digital images. The display may be adjusted by a user and the user may save the display adjustments. A combination of adjustment methods may be employed.

The input device may be a single device or a combination of input devices. For example, the input devices may include a keyboard, both full-sized QWERTY and condensed, a numeric pad, an alpha-numeric pad, a track ball, a touch pad, a mouse, selection buttons, and/or a touch screen. As described above, the display may serve as an input device through using or incorporating a touch screen interface. The devices 110, 120, and 130 may include other devices such as a printer and a device for accepting deposits and/or dispensing currency and coins.

According to some embodiments, the devices 110, 120, and 130 may be financial services devices as described herein. The financial services device may be a transaction device for conducting transactions with the financial institution. For example, the devices 110, 120, and 130 may be a traditional or typical ATM. The devices 110, 120, and 130 may be financial services kiosks. In some embodiments, the devices 110, 120, and 130 may be a portable or hand-held computing or electronic device, or other type of computing device, that has the described functionality. For example, the devices 110, 120, and 130 may be a tablet computing device. Additional devices may be coupled to the portable or hand-held computing device to perform various functions such as accepting deposits or dispensing currency.

The devices 110, 120, and 130 may have a log-in device associated therewith. The log-in device may be used to allow access to the device. The log-in device may require a particular input or it may accept a combination of inputs. The input may serve as an authentication of the user to the device 110, 120, or 130 and the system 100 in general. Various authentication or log-on systems and methods may be used. For example, these methods and systems may include entering a password or PIN (Personal Identification Number) or using a card to log-on, either via swiping the card through a reader, such as a magnetic stripe reader or a smart chip reader, or through a radio frequency system (which may require that the card be placed in proximity to an appropriate reader (i.e., a contactless system), such as RFID (Radio Frequency Identification) or NFC (Near Field Communications). For example, the Blink® system may be used. It should be appreciated that the card may include a combination of a magnetic stripe, a smart chip, and radio frequency. Further, the use of the card is exemplary only and the card may include fobs, stickers, and other devices. Biometrics may be used, such as fingerprints, facial recognition, speech recognition, or retinal scan. A combination of these systems may be used. Biometrics may be used in addition to other log-in methods and systems.

The devices 110, 120, and 130 may provide various functionality and features for conducting transactions with the financial institution. Accordingly, the devices 110, 120, and 130 may be referred to as financial transaction devices. For example, the devices 110, 120, and 130 may be capable of accepting deposits and mixed deposits, withdrawals and multi-denomination withdrawals, coin deposits/withdrawal, check cashing, statement printing, wires, bill pay and check printing. It should be appreciated that the devices 110, 120, and 130 may be capable of other functions and features. Transactions may be supported relating to other financial institutions. For example, the device may be part of a network associated with more than one financial institution. The network may be managed by a third party.

The devices 110, 120, and 130 may be communicatively coupled to a network 135. Accordingly, the devices 110, 120, and 130 may be geographically dispersed. Conversely, two or more of devices 110, 120, and 130 may be located in close proximity to provide a cluster of devices for customer use. For example, the devices may be located within or near a branch office of the financial institution. The devices may be located in other locations such as retailers or merchants. Network 135 may be a computer based network, with one or more servers and/or computer processors. For example, network 135 may be the Internet or a network connected to the Internet. The network 135 may be a satellite or cellular based network. Information and data may be exchanged through the network 135 between the various components of the system 100. In alternative embodiments, the network 135 may be a local area network within the financial institution that may be connected to or interface with the Internet. It should be appreciated that the network 135 may be a combination of local area networks, wide area networks, and external networks, which may be connected to the Internet.

The processing module 140 may be communicatively coupled to the network 135. The processing module 140 may perform operations associated with the establishment, configuration, and application of the programs accordingly to exemplary embodiments. The processing module 140 may consist of one or more servers and/or general purpose computers, each having one or more computer processors associated therewith.

The processing module 140 may have a database 150 communicatively coupled thereto. The database 150 may contain data and information used by the system 100. For example, the database 150 may store account data for financial institution account holders. Additional information maybe contained therein related to the operation and administration of the system 100. The database 150 may include any suitable data structure to maintain the information and allow access and retrieval of the information. For example, the database may keep the data in an organized fashion. The database 150 may be a database, such as an Oracle database, a Microsoft SQL Server database, a DB2 database, a MySQL database, a Sybase database, an object oriented database, a hierarchical database, a flat database, and/or another type of database as may be known in the art that may be used to store and organize rule data as described herein.

The database 150 may be stored in any suitable storage device. The storage device may include multiple data storage devices. The multiple data storage devices may be operatively associated with the database 150. The storage may be local, remote, or a combination thereof with respect to the database. The database 150 may utilize a redundant array of disks (RAID), striped disks, hot spare disks, tape, disk, or other computer accessible storage. In one or more embodiments, the storage may be a storage area network (SAN), an internet small computer systems interface (iSCSI) SAN, a Fiber Channel SAN, a common Internet File System (CIFS), network attached storage (NAS), or a network file system (NFS). The database may have back-up capability built-in. Communications with the database 150 may be over a network, such as the network 135, or communications may be over a direct connection between the database 150 and the processing module 140, as depicted in FIG. 1. Data may be transmitted and/or received from the database 150. Data transmission and receipt may utilize cabled network or telecom connections such as an Ethernet RJ15/Category 5 Ethernet connection, a fiber connection, a traditional phone wireline connection, a cable connection or other wired network connection. A wireless network may be used for the transmission and receipt of data.

The system 100 may have other systems 160 associated therewith. These other systems 160 may include various data collection and support systems used by the financial institution to carry out its functions.

The system 100 may include a portable electronic device 170. The portable electronic device 170 may be more than one portable electronic device. The portable electronic device 170 may be associated with a customer. The customer may interact with the portable electronic device through various input means (not shown). For example, the portable electronic device 170 may have a display screen to convey information to the customer. The display may be a color display. For example, the display may be a Liquid Crystal Display (“LCD”). The portable electronic device 170 may have one or more input devices associated with it. For example, the portable electronic device 170 may have an alpha-numeric keyboard, either physical or virtual, for receiving input. The portable electronic device 170 may have a QWERTY style keyboard, either physical or virtual. The portable electronic device 170 may have a pointing device associated therewith, such as, for example, a trackball or track wheel. As described above, the portable electronic device 170 may have communication capabilities over both cellular and wireless type networks to transmit/receive data and/or voice communications.

The portable electronic device 170, by way of non-limiting examples, may include such portable computing and communications devices as mobile phones (e.g., cell or cellular phones), smart phones (e.g., iPhones, Android based phones, or Blackberry devices), personal digital assistants (PDAs) (e.g., Palm devices), laptops, netbooks, tablets, or other portable computing devices. These portable electronic devices may communicate and/or transmit/receive data over a wireless signal. The wireless signal may consist of Bluetooth, Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet (TCP/IP) Protocols, or other protocols and/or systems suitable for transmitting and receiving data from the portable electronic device. The portable electronic device may use standard wireless protocols which may include IEEE 802.11a, 802.11b, 802.11g, and 802.11n. Such portable electronic devices may be Global Positioning System (GPS) capable. GPS is a satellite based system which sends a signal allowing a device to define its approximate position in a coordinate system on the earth. That is, the portable electronic device may receive satellite positioning data and display the location on the earth of the portable electronic device using GPS. Other location systems may be used. The portable electronic device 170 may include one or more computer processors and be capable of being programmed to execute certain tasks.

The portable electronic device 170 may establish communications with a server 180. Communications may be established over the network 135. Upon successful initiation of communications between the portable electronic device 170 and the server 180, data may be exchanged between the device 170 and the server 180. Data may be transmitted from the portable electronic device 170 to the server 180. Data may be transmitted from the server 180 to the portable electronic device 170.

According to some embodiments, the portable electronic device 170 may interact with the devices 110, 120, or 130. Through the device 110, 120, or 130, the portable electronic device 170 may interact with the server 180 or other parts of the system 100. That is, the device 110, 120, or 130 may serve as an access point to the system 100 for the portable electronic device 170. For example, a user may conduct one or more transactions with the device 110, 120, or 130 using the portable electronic device 170.

It should be appreciated that the server may interact with other parts of the system 100, such as the devices 110, 120, and 130, as well as the processing module 140 and the other systems 160. The server 180 may be a single server or it may be multiple servers. The server 180 may server a variety of roles in the system 100.

The server 180 may have one or more storage devices associated therewith. The storage may be local, remote, or a combination thereof with respect to the server 180. The storage may utilize a redundant array of disks (RAID), striped disks, hot spare disks, tape, disk, or other computer accessible storage. In one or more embodiments, the storage may be a storage area network (SAN), an Internet small computer systems interface (iSCSI) SAN, a Fiber Channel SAN, a common Internet File System (CIFS), network attached storage (NAS), or a network file system (NFS). The storage may have back-up capability built-in. The back-up capability of the storage may be used to archive image data for later use. The back-up capability may be used for recovery of data in the event of a failure of the storage.

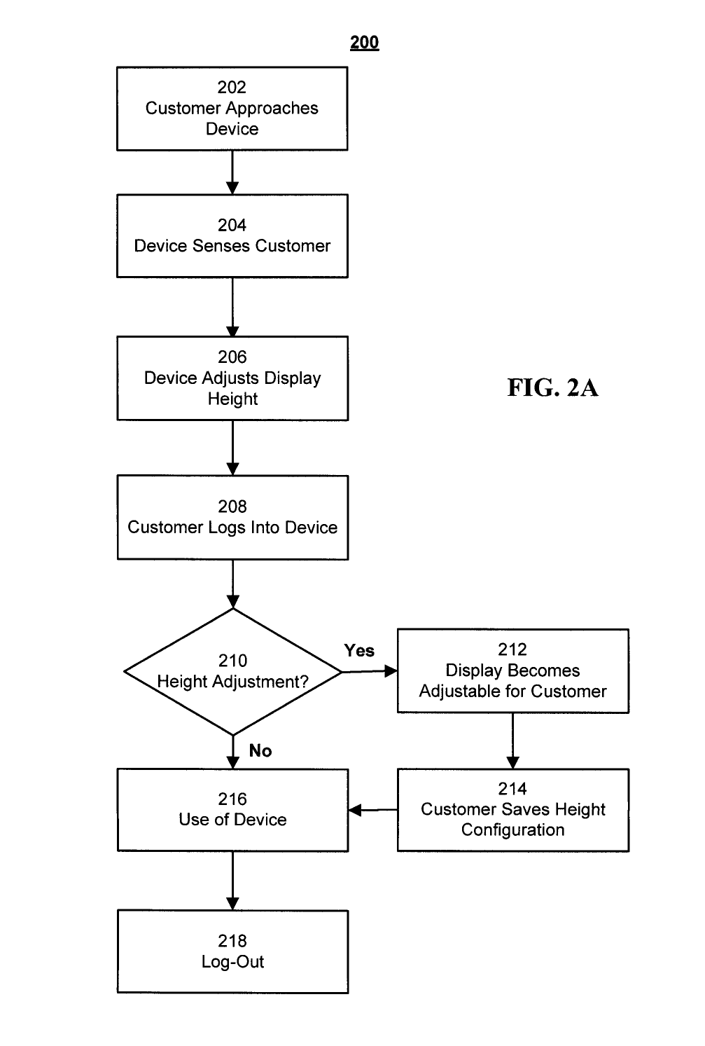

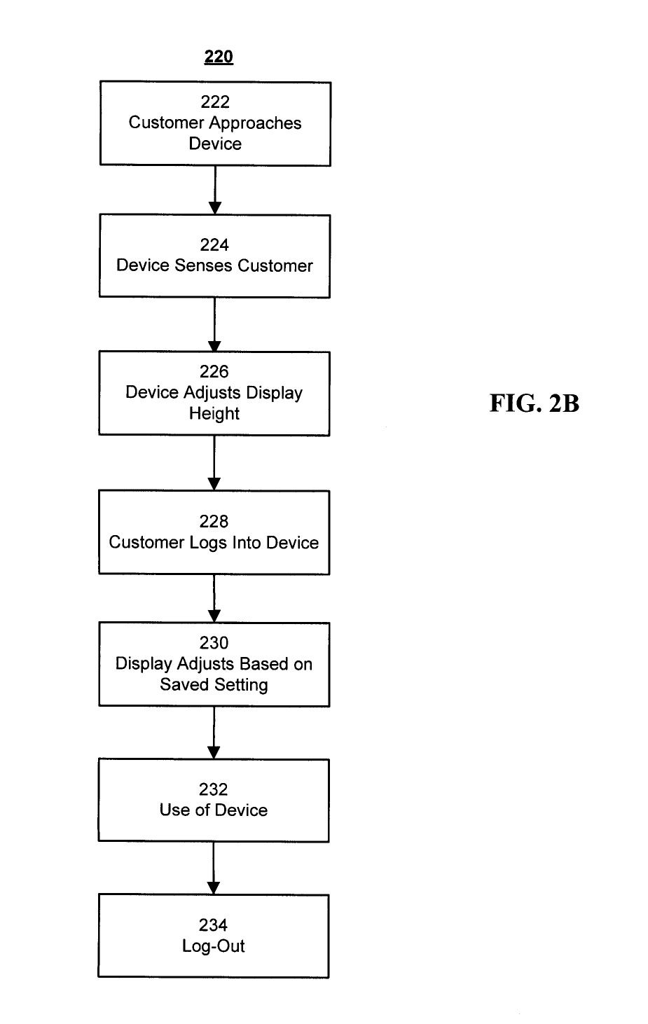

FIG. 2 (which includes FIGS. 2A and 2B) depicts flow charts of a method of interfacing with a financial services device having a height adjustable display according to exemplary embodiments of the invention. Exemplary method 200 is provided by way of example, as there are a variety of ways to carry out the methods disclosed herein. The method 200 and 220 as shown in FIGS. 2A and 213 may be executed or otherwise performed by one or a combination of various systems, such as a computer implemented system. Each block shown in FIGS. 2A and 2B represents one or more processes, methods, and/or subroutines carried out in the exemplary method 200 and 220. Each block may have an associated processing machine or the blocks depicted may be carried out through one processor machine.

Referring to FIG. 2A, at block 202, a customer approaches a device. The device may be a financial services kiosk or an ATM for example. The device, according to exemplary embodiments, may have a large display area located in the front portion of the device. The display area may be used to display information for the customer. The device may have more than one display. The display may be a touch screen type display such that the customer may interact with the display through the use of their fingers.

The device may be located in or near a branch office of a financial institution which may include banks, credit unions, etc. The device may be located at a retailer or merchant. For example, a financial institution may have an agreement with a merchant to allow a financial services kiosk according to exemplary embodiments to be located near or within a merchant's location. The customer may have one or more accounts with the financial institution. It should be appreciated that the customer may be associated with a different financial institution but may still be able to use the device.

According to exemplary embodiments, the device may be a portable electronic device. For example, the device may be a tablet or a tablet PC. The device may also be a computer, such as a laptop or netbook. The device may be configured to serve as a portable financial services device for conducting transactions with the financial institution. The device may have functions and features to facilitate the conduct of transactions with the financial institution. According to some embodiments, the customer may have their own portable electronic device. For example, the device may be a cell phone, PDA, smart phone, tablet, netbook, laptop, or other portable computing device that is associated with the customer. That is, the device may not be the property of or associated with the financial institution. In this embodiment, the portable electronic device may be used for interaction with the device.

At block 204, the device senses the customer. Upon the customer approaching the device, the device may sense the customer. The sensing may occur at a predetermined distance from the device. In other embodiments, the customer may be instructed to stand at a particular position in front of the device to facilitate the sensing. In some embodiments, the sensing may occur upon the customer touching, contacting, or otherwise interacting with the device. The sensing may involve the device acknowledging or indicating the customer's presence. For example, the device may “turn-on” or otherwise activate in a manner visible to the customer.

The sensing may be performed in a variety of manners. For example, the sensing may occur through interaction or contact with the device as previously described. The sensing may be performed using one or more sensors. For example, a digital camera or an optical device may be used. The sensors may be heat sensing. A combination of sensors may be used. The plurality of sensors may be located a various positions on the device. According to exemplary embodiments, the sensors may be located in the front portion of the device. However, sensors may be located on the sides or the back of the device to account for differing approach angles to the device. The device may use audio functions to convey a message to the customer regarding the sensing. For example, the device may use a voice message to instruct the customer to stand in a particular position to complete the sensing.

At block 206, the device adjusts the display height. Once the customer is sensed, the device may adjust the display height. The adjustment may be such that the display is raised or lowered to a position located in front of the sensed facial height of the customer. The adjustment may be based upon a calculation performed using data from the sensor(s). The display may move then may turn on for the customer. In some embodiments, the customer may be able to visually observe the display being adjusted.

A block 208, the customer logs onto/into device. The log in may be performed using a designated log-on method for the device. The device may offer more than one log on method. This process may serve to authenticate the customer's identity. Various methods may be used to authenticate the customer and allow them to access the device. For example, the customer may swipe or otherwise present a card or similar designated device, or enter a password or PIN into an alphanumeric entry device. The customer may use a portable electronic device to log-on to the device using a wireless communication path. Other log-in methods are possible, such as biometrics. For example, a fingerprint scan or retinal scan may be used to log into the device. A combination of log-on methods may be employed. For example, the customer may provide a retinal scan and then enter a code into a keypad.

At block 210, a second height adjustment may be performed. Upon a successful log-on, the customer may be presented with the option of performing an additional height adjustment. If the customer desires to pursue this adjustment, the method continues a block 212, otherwise, the method continues at block 216.

At block 212, the display may become adjustable for the customer to move it themselves. For example, the display may be movable through the customer performing a swipe or other gesture with their fingers. The display may be electronically slidable through the customer placing their fingers at a location where they desire the display.

At block 214, the customer may be presented with the option of saving the height adjustment for future use. In this manner, the customer may save this height adjustment as a customized setting. It should be appreciated that the customer may save the height setting even if they did not manually adjust the height. An option may be provided to save the first height adjustment if the customer is happy with it and does not desire to adjust the height further.

At block 216, the customer uses the device. The device may be used through a set of menu options for performing various actions. For example, the customer may use the device to conduct one or more financial transactions, such as, but not limited to, a deposit or cash withdrawal. A variety of other transactions may be performed as appreciated by one of ordinary skill in the art.

At block 218, a log-out of the device is performed. The customer may log-out of the device, ending the present session.

Another exemplary method is shown in FIG. 2B. At block 222, a customer approaches a device, as described at block 202. At block 224, the device senses the customer, as described at block 204. At block 226, the device adjusts the display height, as described at block 206. A block 228, the customer logs onto/into device using a designated log-on method, as described at block 208. At block 230, the display height is adjusted based upon a saved setting. The height setting may be a customized setting the customer has previously set as described above at block 214. At block 232, the customer uses the device, as described at block 216. At block 234, a log-out of the device is performed, as described at block 218.

According to some embodiments, the device may support various modifications to support the Americans with Disabilities Act (“ADA”). For example, the device may be sized to support wheelchair bound persons or persons of shorter stature. The height detection, display screens, and height adjustment functions may be modified as appropriate. The display screen may be tiltable or otherwise adjustable in different dimensions to support lower viewing angles.

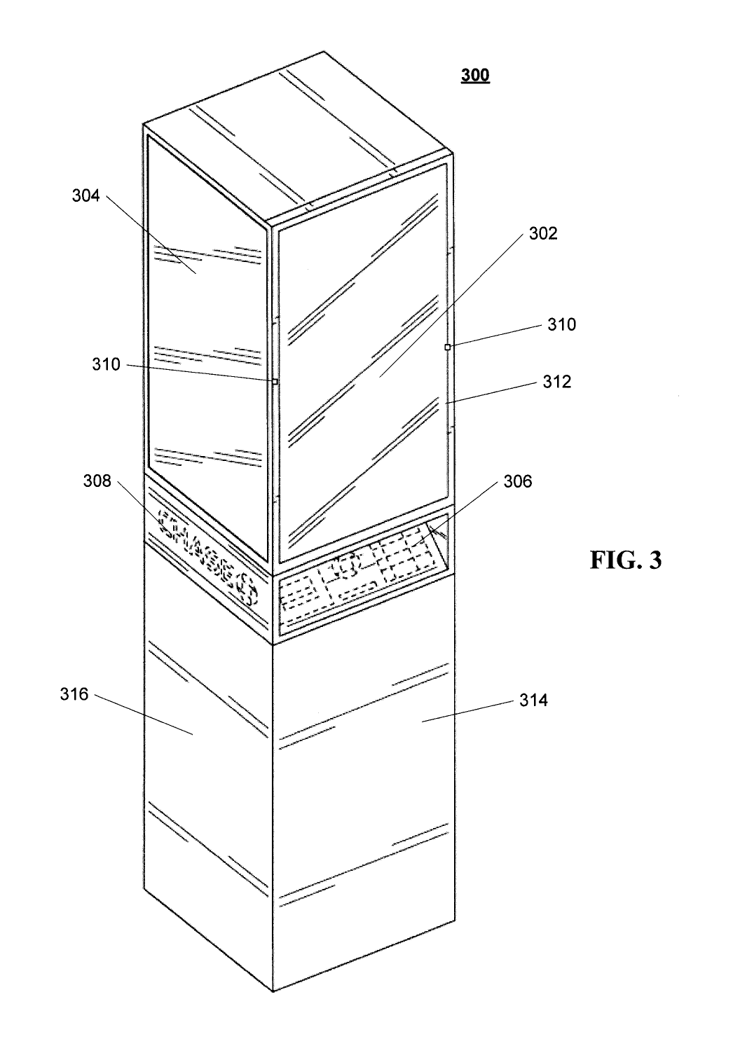

FIG. 3 depicts a device for financial transactions according to exemplary embodiments. The device 300 may be a financial services device. For example, the device may be an ATM or a financial services kiosk. It should be appreciated that other shapes and variations on the shape shown are possible. The device 300 depicted is meant to be non-limiting and exemplary only.

The device 300 may have a front display screen 302. Side display screens 304 may also be present. An input area 306 may be present. A band 308 may be present on which the name of the device 300 associated financial institution may be display.

The front display screen 302 may be a touch screen display. The front display screen 302 may be used for display of information for the customer. The active display portion may be a smaller sub-set of the total screen area. This sub-set display may be adjustable in height as described herein. The remainder of the screen area 302 may be used for display of additional information for the customer. For example, advertising may be displayed. In some embodiments, the front display screen 302 may support three-dimensional or 3-D images. The display screen may provide an illusion of 3-D without being in actual 3-D. In some embodiments, the front display screen 302 may be tiltable or otherwise movable to provide different viewing angles. These adjustments may be manually performed by the customer or may be electronically controlled from a set of menu options on the display screen. In this manner, the screen position may be adjusted to ensure the optimal viewing angle for the customer.

The side display screen 304 may be used to display advertising or other messages/information by the financial institution. A side display screen 304 may be present on the opposite side from that shown. Both displays may show the same information. In some embodiments, different information may be shown on the side display screens. In some embodiments, the side display screen 304 may support three-dimensional or 3-D images. The display screen may provide an illusion of 3-D without being in actual 3-D.

The input area 306 may be used for receiving customer input to the device 300. The input area 306 may be part of a display screen also. For example, the input area 306 may be a virtual input area. In some embodiments, the input area 306 may be a physical area. For example, a physical keypad and/or keyboard may be present. The input area 306 may have a card slot for insertion of a card to log in. A biometric sensor may be present in this input area. According to some embodiments, the input area 306 may be incorporated into the front display screen 302.

The band 308 may be used for decoration. For example, a financial institution's name and symbol may be shown on the band 308 as depicted. According to some embodiments, the band 308 may be a display screen such that the information contained thereon is electronically generated and displayed thereon.

As described above, the device 300 may have one or more sensors located therein or thereon. The sensors may not be visible to the customer. For example, the device 300 may have a sensor 310 located on each side of the front display 302. A plurality of sensors 310 (that is, more than the two shown) may be located around the periphery 312 of the front display screen 302. A series of sensors may ring the front display screen 302 to ensure the best possible sensing of the customer given that customers may have a range of heights. The sensors may be spaced apart with the periphery 312. It should be appreciated that sensors 310 may also be located on the lower half of the device 300; that is, below the input area 306.

The sensors 310 may be optical sensors. For example, the sensors 310 may be digital cameras or equivalent devices. The sensors may be positioned such that they are angled or otherwise positioned to focus on a particular area in space in front of the device 300 to sense the customer at a predetermined distance from the device. The sensors may incorporate facial recognition technology. For example, the sensors may image or otherwise detect the customer. The customer's facial area may be recognized by the sensors. The device 300 may then compute the height of the customer's face. Using that computation, the screen height may be adjusted. Other types of sensors may be used. According to some embodiments, a combination of sensor types may be used.

In some embodiments, the device 300 may have additional display screens located on its lower half at 314 and 316. These display screens may be optional. The display screens 314 and 316 may be used to display advertising or other information for the customer. In some embodiments, the display screens 314 and 316 may support three-dimensional or 3-D images. The display screen may provide an illusion of 3-D without being in actual 3-D.

To support persons with lower viewing heights, the display screen 314 may be used to display an active screen for customer interaction. For example, upon sensing a person in a wheelchair or a person of short stature, with a lower viewing height than the front display screen 302 is capable of providing, the device 300 may shift the customer display to display 314 and use the front display 302 for advertising. In such a manner, the wheelchair bound person may interact with the device 300.

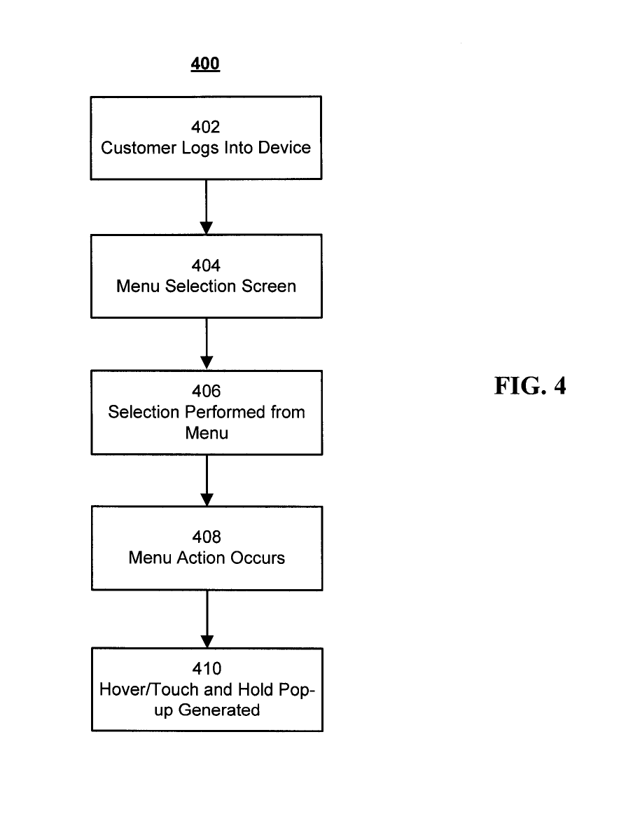

FIG. 4 depicts a flow chart of a method of interfacing with a financial services device having hover feature according to exemplary embodiments of the invention. Exemplary method 400 is provided by way of example, as there are a variety of ways to carry out the methods disclosed herein. The method 400 as shown in FIG. 4 may be executed or otherwise performed by one or a combination of various systems, such as a computer implemented system. Each block shown in FIG. 4 represents one or more processes, methods, and/or subroutines carried out in the exemplary method 400. Each block may have an associated processing machine or the blocks depicted may be carried out through one processor machine.

At block 402, a customer logs into a device. The device may be a financial services kiosk or an ATM as described herein. For example, the device may be the device 300 as depicted in FIG. 3. The customer may log into the device as described above in FIG. 2A, for example.

At block 404, a menu selection screen is displayed. The menu selection screen may provide a set of options from which the customer can select.

At block 406, a menu selection is selected. The customer may select a menu selection.

At block 408, an action may occur. Selection of a menu item may cause an action to occur. For example, each selection item on the menu may either provide information to the customer or provide a new set of menu selections. The menu selection may cause a physical action to occur such as, by way of non-limiting example, dispensing cash to the customer or causing a deposit slot to open.

At block 410, a hover item may appear. Certain menu selections may have a hover/touch and hold capability. For these selections, through a prolonged contact with the menu icon on the screen, a pop-up balloon or box may appear on the screen. The period of prolonged contact necessary to generate the pop-up may be set at a time that is longer than a typical contact to normally or typically select a menu item. This pop-up may only appear as long as the contact with the menu icon is maintained. In this sense, the pop-up is ephemeral in nature and the pop-up may appear to “hover” on the screen through the touch and hold action being performed. The pop-up may contain information for the customer. For example, a menu icon for account balance may be selected. The customer may hold their finger on the menu icon and a pop-up may contain a balance listing for each of the customer's account. Upon removal of their finger, the pop-up may disappear. This feature may be used to increase security by preventing on-lookers near the device from seeing sensitive financial information since the customer can fully control when such information is displayed.

According to some embodiments, the pop-up may allow for selection of items displayed therein. For example, the customer may use their other hand to select an item from the pop-up while it is displayed. The selection may cause another display to appear and the first pop-up to disappear. In this manner, the hover feature may be used to provide a layered set of menu selections for the customer.

According to some embodiments, the customer may configure particular hover actions for their account to customize their experience. For example, certain menu selections may be configurable to be hover/touch and hold capable. If not configured in this manner, the menu selections may generate the information on a new screen or on the screen after being pressed. That is the display of the information may be generated without a touch and hold and be displayed until another action is selected.

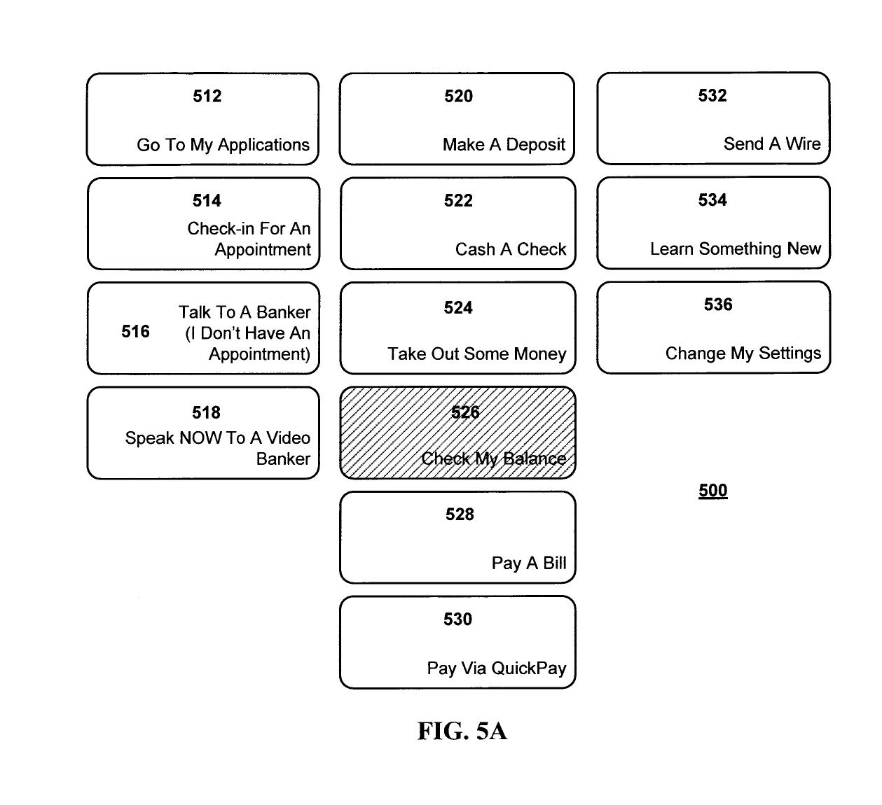

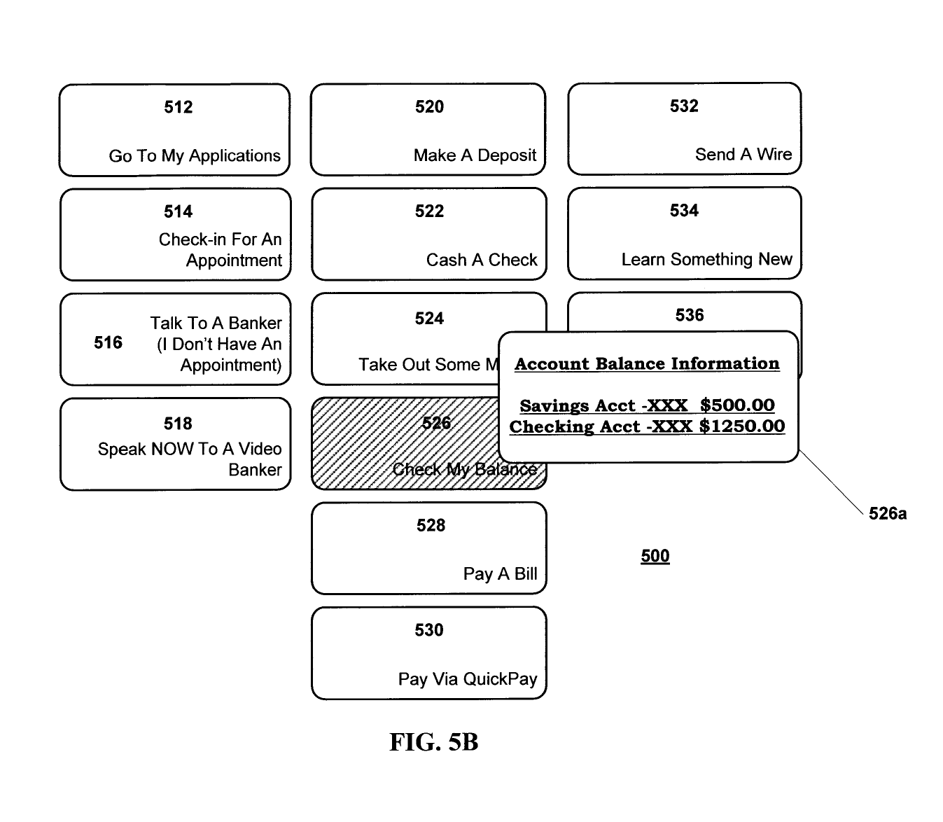

FIGS. 5A and 5B depict an exemplary screen of a financial services device according to an exemplary embodiment. The contents of the screen depicted in FIGS. 5A and 5B, such as the menu selections, are meant to be exemplary only and non-limiting. The screen 500 may appear upon the front display screen 302 as shown for the device 300 depicted in FIG. 3. The screen 500 may occupy a portion of the front display screen 302. The screen 500 may be adjustable in height as described herein. The screen 500 may have menu selections 512, 514, 516, 518, 520, 522, 524, 526, 528, 530, 532, 534, and 536 thereon. These menu selections may be touch selectable to activate their functions. For example, to make a deposit, the customer may choose menu selection 520.

According to exemplary embodiments, the menu selection 526 (“Check My Balance”) may be hover/touch and hold enabled. As depicted in FIG. 5A, the menu selection 526 may have a differing appearance from the other menu selections to denote the feature. The customer may have selected this as an option using the menu selection 536 (“Change My Settings”) in a previous transaction or interaction with the screen 500. In some embodiments, the financial institution may have enabled this feature. That is, the financial institution may have configured the display to highlight the menu selection 526. In such an embodiment, the feature may not be selectable or changeable by the customer. In other embodiments, the customer may have control over the appearance of the menu selections. The customer may further have control over the colors, font, text, etc. shown on the screen 500. These options may be customizable to the customer's desires.

In FIG. 5B, a pop-up 526a is depicted. The pop-up 526a shows account balance information. The pop-up 526a may originate or appear when the menu selection 526 is contacted for an extended period of time. The pop-up 526a, as depicted in FIG. 5B, may appear over the menu selections on the screen. The pop-up 526a may only remain on the screen for as long as the contact with the menu selection 526 is maintained. Once contact is broken, the pop-up 526a may disappear from the screen 500. The positioning of the pop-up 526a is meant to be exemplary and non-limiting and the pop-up 526a may appear in any location on the screen 500.

In some embodiments, the customer may configure the location of the pop-up. The pop-up 526a, as depicted, may have a different color, font, and/or shape from the existing menu selections on the screen 500 to distinguish it. For example, the pop-up 526a may use a bold underlined font for its text as depicted, whereas the other menu selections do not. These features may also be configurable by the customer.

It should be appreciated that the pop-up or hover feature described above may be used on a portable electronic device. For example, a customer may use a portable electronic device to access or interface with a financial transaction device. A menu selection screen for transactions as shown in FIGS. 5A and 5B may appear on the portable electronic device. This menu selection screen may implement the pop-up feature as described.

According to some embodiments, the hover feature may have an audio component to support visually impaired customers. The financial services device may have features enabling visually impaired customers to interact therewith. For example, a Braille input keyboard may be available. The financial services device may accept audio (e.g., voice) commands. The financial services device may respond to these voice commands with audio responses. To provide privacy and security, a headset or other device may be provided. The headset may have a microphone to enable the voice commands to be given and headphones to allow for output from the machine. A variety of language support may be provided. For example, the financial services device may support English and other languages common in the area it is located.

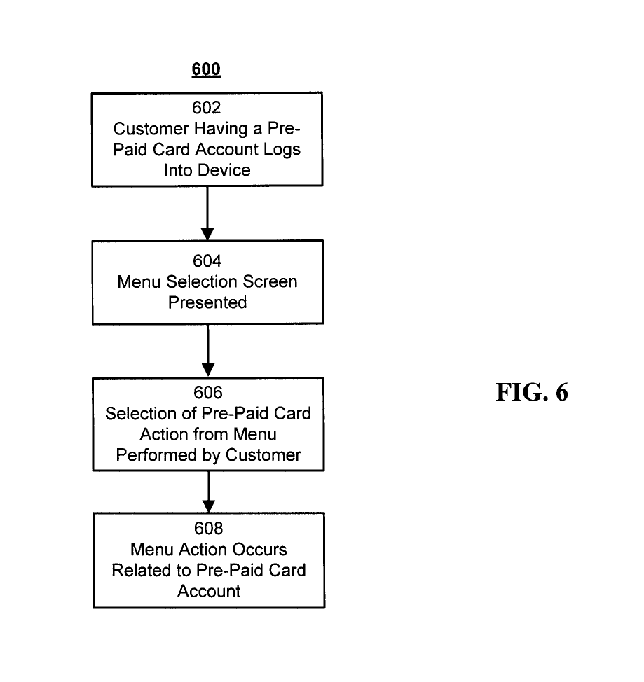

FIG. 6 depicts a method of conducting a transaction for a pre-paid card at a financial services device according to an exemplary embodiment. Exemplary method 600 is provided by way of example, as there are a variety of ways to carry out the methods disclosed herein. The method 600 as shown in FIG. 6 may be executed or otherwise performed by one or a combination of various systems, such as a computer implemented system. Each block shown in FIG. 6 represents one or more processes, methods, and/or subroutines carried out in the exemplary method 600. Each block may have an associated processing machine or the blocks depicted may be carried out through one processor machine. Furthermore, the terms “pre-paid card” and “stored value card” as used herein are meant to be interchangeable and reference to one type is not meant to exclude the other. It should be appreciated that a pre-paid card and a stored value card, as known in the art, may have different characteristics and features and the interchanging of terms herein is not meant to imply that these card types, in all cases, have the same characteristics and/or features. It should further be appreciated that the pre-paid or stored value card may be a physical card and/or a virtual card.

At block 602, a customer logs into a device. The device may be a financial services kiosk or ATM as described herein. For example, the device may be the device 300 as depicted in FIG. 3. The customer may log into the device as described above in FIG. 2A. The customer may have a pre-paid card account with the financial institution associated with the financial services device; additionally, the customer may have one or more financial accounts with the financial institution. According to exemplary embodiments, have such financial accounts may be a pre-requisite for accessing the financial services device. That is, the customer may be required to have a pre-existing relationship with the financial institution.

According to some embodiments, the financial services device may be interacted with using a portable electronic device associated with the customer. The device may support a wireless interface for communicative coupling with the portable electronic device. The wireless interface may be a wireless signal as part of a wireless network (“wi-fi”), infrared, radio frequency identification interface (“RFID”), near field communications (“NFC”), or an optical interface. A combination of wireless interfaces may be used. The type of wireless interface impacts the degree of communicative coupling and the information exchange that can occur between the kiosk and the portable electronic device. Using a wireless signal or wireless network interface may enable two way communications and exchange of data between the kiosk and the portable electronic device. This may enable the customer to conduct a full range of transactions. Other interfaces may be limited in communication capability.

The portable electronic device may be associated with the customer. For example, the customer may be the owner of the portable electronic device. The customer may access an application, widget, or other interface or program associated with the financial institution on their portable electronic device to enable interaction with the financial services device.

An optical interface, such as a QR code, may be used to provide a wireless interface. A QR code is provided as a non-limiting example. The device may provide the customer a display of a QR code. The customer may image the QR code with their portable electronic device. Through imaging this QR code, log-in instructions or a link, may be provided to enable the portable electronic device to interface with the device.

For example, according to some embodiments, a customer may image, using a portable electronic device, a QR code or other code from the display of their home computer or other computer. The customer may approach the device and display the QR code image to the device at a designated location. The device may image the QR code from the portable electronic device and access the customer's account. The customer's account may be a pre-paid card account. In this manner the customer may log into the device.

At block 604, a menu selection screen is displayed. The menu selection screen may provide a set of options from which the customer can select. According to exemplary embodiments, the menu selection may include options relating to transactions for pre-paid cards. The set of options may include adding funds to card, removing funds from card, transfer between pre-paid cards, transfer to or from a pre-paid card and bank account (for example, a demand deposit account or DDA), balance inquiry, transaction inquiry, and generate a statement. These options are meant to be exemplary and non-limiting. It should be appreciated that other options for transactions are possible.

The pre-paid card options may appear to customers having a pre-paid card and an account with the financial institution associated with the financial services device. The pre-paid card may have to be registered or otherwise associated with the customer and their financial institution so that the options may appear upon customer log-in. It should be appreciated that the presented options may include the hover/touch and hold features described herein. For example, the balance inquiry menu selection may support this feature.

At block 606, a menu selection is selected. The customer may select a menu selection to perform the desired transaction. The menu selection may pertain to the pre-paid card account.

At block 608, the selected menu action occurs. To support interaction with a physical pre-paid card, the device may have a card slot or other device/interface supporting card interaction, such as an radio frequency identification or near field communications location. The customer may interface their pre-paid card with the device using the slot or interface. The device may be capable of altering information stored on the pre-paid card, such as through modifying a magnetic stripe or programming a smart chip or other card feature. For example, the customer may add funds to the pre-paid card and the device may update the card to reflect the added funds. In some embodiments, no interaction with a physical card is required as the card records are modified electronically to reflect any modifications to the card account.

In some embodiments where an electronic or virtual pre-paid card is involved, to complete the action, the device may provide a QR code or other image on its display. The customer may use a portable electronic device to image this code. Upon imaging and decoding the QR code, the electronic card may be modified as desired by the customer based on the selected action.

It should be further appreciated that transactions may occur between different pre-paid cards and pre-paid card accounts. For example, a customer may have multiple pre-paid cards. The menu options may support transactions, such as balance and value transfer, between these multiple pre-paid cards. Likewise, the multiple cards may be associated with multiple accounts, between which transactions may be conducted, such as balance or value transfers. In some embodiments, transactions between cards and/or accounts associated with different customers may be supported. For example, customer A may be able to transfer value to customer B. The value transfer may be between pre-paid cards. During such a transfer between customer's, the receiving customer (e.g., customer B) may be notified, such as, for example, by text message or email, of the transaction conducted by the initiating customer (e.g., customer AO so they are aware of the transaction. The receiving customer may have to perform an acceptance action for the transaction to be complete. For example, the receiving customer may have to proceed to a financial services device and log-in and perform one or more menu selections as described herein. In alternative embodiments, customer A may initiate the transaction through a website and customer B may complete the transaction at a financial services device, such as a financial services kiosk or ATM.

Hereinafter, aspects of implementation of the inventions will be described. As described above, the method of the invention may be computer implemented as a system. The system of the invention or portions of the system of the invention may be in the form of a “processing machine,” for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

The description of exemplary embodiments describes servers, portable electronic devices, and other computing devices that may include one or more modules, some of which are explicitly depicted in the figures, others are not. As used herein, the term “module” may be understood to refer to executable software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices (e.g., servers) instead of or in addition to the function performed at the particular module. Further, the modules may be implemented across multiple devices and/or other components local or remote to one another. Additionally, the modules may be moved from one device and added to another device, and/or may be included in both devices. It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof. Moreover, the figures illustrate various components (e.g., servers, portable electronic devices, client devices, computers, etc.) separately. The functions described as being performed at various components may be performed at other components, and the various components may be combined and/or separated. Other modifications also may be made.

According to exemplary embodiments, the systems and methods may be computer implemented using one or more computers, incorporating computer processors. The computer implementation may include a combination of software and hardware. The computers may communicate over a computer based network. The computers may have software installed thereon configured to execute the methods of the exemplary embodiments. The software may be in the form of modules designed to cause a computer processor to execute specific tasks. The computers may be configured with hardware to execute specific tasks. As should be appreciated, a variety of computer based configurations are possible.

The processing machine described above may also utilize any of a wide variety of other technologies including a special purpose computer, a computer system including a microcomputer, mini-computer or mainframe for example, a programmed microprocessor, a micro-controller, a PICE (peripheral integrated circuit element), a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices for example capable of implementing the steps of the process of the invention.

It is appreciated that in order to practice the method of the invention as described above, it is not necessary that the processors and/or the memories of the processing machine be physically located in the same geographical place. For example, each of the processors and the memories and the data stores used in the invention may be located in geographically distinct locations and connected so as to communicate in any suitable manner. Additionally, it is appreciated that each of the processor and/or the memory and/or data stores may be composed of different physical pieces of equipment. Accordingly, it is not necessary that the processor be one single piece of equipment in one location and that the memory be another single piece of equipment in another location. For example, it is contemplated that the processor may be two or more pieces of equipment in two or more different physical locations. These two or more distinct pieces of equipment may be connected in any suitable manner. Additionally, the memory may include two or more portions of memory in two or more physical locations. Additionally, the data storage may include two or more components or two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions. It is also appreciated that the data storage performed by two distinct components as described above may, in accordance with a further embodiment of the invention, be performed by a single component. Further, the data storage performed by one distinct component as described above may be performed by two distinct components.

Further, various technologies may be used to provide communication between the various processors and/or memories, as well as to allow the processors and/or the memories of the invention to communicate with any other entity; e.g., so as to obtain further instructions or to access and use remote memory stores, for example. Such technologies used to provide such communication might include a network, such as a computer network, for example, the Internet, Intranet, Extranet, LAN, or any client server system that provides communication of any capacity or bandwidth, for example. Such communications technologies may use any suitable protocol such as TCP/IP, UDP, or OSI, for example. It should be appreciated that examples of computer networks used in the preceding description of exemplary embodiments, such as the Internet, are meant to be non-limiting and exemplary in nature.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming or any other suitable programming form. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. For example, written lines of programming code or source code, in a particular programming language, are converted to machine language using a compiler, assembler or interpreter. The machine language is binary coded machine instructions that are specific to a particular type of processing machine, e.g., to a particular type of computer, for example. The computer understands the machine language.

Any suitable programming language may be used in accordance with the various embodiments of the invention. Illustratively, the programming language used may include assembly language, Ada, APL, Basic, C, C++, C#, COBOL, dBase, Forth, Fortran, Java, Modula-2, Pascal, Prolog, REXX, Ruby, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, e.g., the software for example, that enables the computer operating system to perform the operations described above may be contained on any of a wide variety of computer readable media, as desired. Further, the data for example processed by the set of instructions might also be contained on any of a wide variety of media or medium. For example, the particular medium, e.g., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, e.g., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

While the embodiments have been particularly shown and described within the framework of financial services devices, it will be appreciated that variations and modifications may be effected by a person of ordinary skill in the art without departing from the scope of the invention. Furthermore, one of ordinary skill in the art will recognize that such processes and systems do not need to be restricted to the specific embodiments described herein. Other embodiments, combinations of the present embodiments, and uses and advantages of the present invention will be apparent to those skilled in the art from consideration of the specification and practice of the invention disclosed herein. The specification and examples should be considered exemplary.

1. A computer implemented method, comprising:
detecting, by a computer processor, a presence of a customer at a financial transaction device, wherein detecting comprises recognizing a facial area of the customer by one or more sensors;
providing, by the financial transaction device, a first display screen, a second display screen, and an active display screen, wherein the active display screen is a smaller sub-set of the first display screen;
computing a height of the facial area of the customer;
calculating a viewing height of the customer, based on the detected presence and the computed height of the facial area of the customer;
adjusting, electronically, the active display screen to a first position within the first display screen according to the calculated viewing height of the customer;
receiving a log-on request at the financial transaction device; and
providing an option for the customer to adjust the active display screen to a second position.

2. The method of claim 1, further comprising:
providing an option for the customer to save the second position of the active display screen.

3. The method of claim 2, wherein the saved second position is accessible during a subsequent log-on to the financial transaction device.

4. The method of claim 1, wherein adjusting the active display screen to the first position comprises adjusting a vertical height of the active display screen.

5. The method of claim 1, wherein detecting the presence of the customer comprises performing facial recognition on the customer using one or more optical devices.

6. The method of claim 1, wherein the first position and the second position are different.

7. (canceled)

8. The method of claim 1, wherein the first display screen is a touch screen display and provides an interface for interaction with the financial transaction device.

9. A computer implemented method, comprising:
detecting, by a computer processor, a presence of a customer at a financial transaction device, wherein detecting comprises recognizing a facial area of the customer by one or more sensors;
providing, by the financial transaction device, a first display screen, a second display screen, and an active display screen, wherein the active display screen is a smaller sub-set of the first display screen;
computing a height of the facial area of the customer;
calculating a viewing height of the customer, based on the detected presence and the computed height of the facial area of the customer;
adjusting, electronically, the active display screen to a first position within the first display screen according to the calculated viewing height of the customer;
receiving a log-on request at the financial transaction device; and
positioning, by the computer processor, the active display screen to a second position based on a saved setting associated with the customer following completion of the log-on request.

10. The method of claim 9, wherein the saved setting was configured by the customer during a previous log-on to the financial transaction device.

11. The method of claim 9, wherein the first position and the second position are different.

12. The method of claim 9, wherein adjusting the active display screen to the first position comprises adjusting a vertical height of the active display screen.

13. The method of claim 9, wherein detecting the presence of the customer comprises performing facial recognition on the customer using one or more optical devices.

14. (canceled)

15. The method of claim 9, wherein the first display screen is a touch screen display and provides an interface for interaction with the financial transaction device.

16. A financial transaction device, comprising:
an interface for customer interaction;
at least one sensing device capable of detecting a presence of a customer, wherein detecting comprises recognizing a facial area of the customer;
one or more computer processors capable of computing a height of the facial area of the customer, and calculating a viewing height of the customer, based on the detected presence and the computed height of the facial area of the customer;
an active display screen, wherein the active display screen is a smaller sub-set of a first display screen;
a second display screen;
a first display surface capable of electronically displaying the first display screen, and the active display screen, the active display screen being electronically movable at least on the first display surface in response to the detected presence of the customer such that upon detecting the presence of the customer the financial transaction device automatically adjusts the positioning of the active display screen to a first position within the first display screen according to the calculated viewing height of the customer.

17. The financial transaction device of claim 16, wherein the active display screen provides the interface.

18. The financial transaction device of claim 16, wherein the at least one sensing device comprises an optical sensing device.

19. The financial transaction device of claim 18, wherein the optical sensing device is capable of facial recognition.

20. The financial transaction device of claim 16, wherein the at least one sensing device is capable of facial recognition.

21. A computer implemented method, comprising:
receiving, by a computer processor, a menu selection on a first touch display screen associated with a financial transaction device; and
causing, by the computer processor, a pop-up display to appear containing information related to the menu selection wherein the pop-up display appears in response to contact with the first touch display screen for a predetermined amount of time, wherein the pop-up screen appears as a smaller sub-set of the first touch display screen;
providing, by the financial transaction device, a second touch display screen;
detecting, by the computer processor, a presence of a customer at the financial transaction device, wherein detecting comprises recognizing a facial area of the customer by one or more sensors;
computing a height of the facial area of the customer;
calculating a viewing height of the customer, based on the detected presence and the computed height of the facial area of the customer;
adjusting, electronically, the pop-up display to a first position according to the calculated viewing height of the customer on the financial transaction device in response to the detected presence, wherein the first position comprises at least one of a position within the first touch display screen and a position within the second touch display screen.

22. The computer implemented method of claim 21, wherein the predetermined amount of time is a period of time that is longer than contact required to actuate a menu selection under normal conditions.

23. The computer implemented method of claim 22, wherein the pop-up display disappears upon breaking of the contact.

24. The computer implemented method of claim 21, wherein the pop-up display appears to hover over other contents of the first touch display screen.

25. The computer implemented method of claim 21, wherein a plurality of menu selections are displayed and a sub-set of the plurality of menu selections have corresponding pop-up displays.

26. The computer implemented method of claim 25, wherein the sub-set has a different appearance on the first touch display screen.

27. The computer implemented method of claim 25, wherein the sub-set is configurable by a user.

28. The computer implemented method of claim 21, further comprising:
causing the pop-up display to disappear upon breaking of contact with at least the first touch display screen.

29. The computer implemented method of claim 21, wherein the contact comprises a user touching at least the first touch display screen.

30. The computer implemented method of claim 21, further comprising:
receiving a log-on request at the financial transaction device; and
providing an option for the customer to adjust the pop-up display to a second position.

31. The computer implemented method of claim 21, further comprising:
receiving a log-on request at the financial transaction device; and
positioning, by the computer processor, the pop-up display to a second position based on a saved setting associated with the customer.

32. A computer implemented method, comprising:
detecting, by a computer processor, a presence of a customer at a financial transaction device, wherein detecting comprises recognizing a facial area of the customer by one or more sensors;
providing, by the financial transaction device, a first touch display screen, a second touch display screen, and an active touch display screen, wherein the active touch display screen is a smaller sub-set of the first touch display screen;
computing a height of the facial area of the customer;
calculating a viewing height of the customer, based on the detected presence and the computed height of the facial area;
adjusting, electronically, the active touch display screen to a first position on the first touch display screen on the financial transaction device according to the calculated viewing height of the customer;
receiving a log-on request at the financial transaction device;
presenting, electronically, a set of menu selections on the active touch display screen;
receiving, by the computer processor, a first menu selection, from the set of menu selections, on the active touch display screen;
causing, by the computer processor, a pop-up display to appear on the active touch display screen containing information related to the first menu selection wherein the pop-up display appears in response to contact with the active touch display screen for a predetermined amount of time; and
causing, by the computer processor, the pop-up display to disappear upon breaking of contact with the active touch display screen.

33.-43. (canceled)

44. The method of claim 1, further comprising: moving, electronically, the active display screen from the first display screen to the second display screen, upon calculating that the viewing height of the customer is lower than a specified height.
